(19) United States
(12) Patent Application Publication
(10) Pub. No.: US 2015/0207787 A1
(43) Pub. Date: Jul. 23, 2015

(54) TECHNIQUES FOR SECURE DATA TRANSACTIONS

(71) Applicant: CARIN RENE CANNELL, YUMA, AZ (US)

(72) Inventor: CARIN RENE CANNELL, YUMA, AZ (US)

(21) Appl. No.: 14/602,872

(22) Filed: Jan. 22, 2015

Related U.S. Application Data
(60) Provisional application No. 61/930,541, filed on Jan. 23, 2014.

(51) Int. Cl. H04L 29/06

(52) U.S. Cl. CPC H04L 63/08

(57) ABSTRACT

According to certain inventive techniques, a first client requests information from a second client by communicating with a data processing system. The data processing system authenticates the identities of the clients and determines if they are authorized to communicate with each other. If authorized, the data processing system facilitates the transfer of the requested information to the first client without ever receiving the requested information. Thus, data can be transferred via the Internet between parties while maintaining the security and privacy of all involved parties without exposing the data processing system and the company that operates it to the risks associated with the transmission of private data.

### FEDERALLY SPONSORED RESEARCH OR DEVELOPMENT

[Not Applicable]

### CROSS REFERENCE TO RELATED APPLICATIONS

[Not Applicable]

### JOINT RESEARCH AGREEMENT

[Not Applicable]

### SEQUENCE LISTING

[Not Applicable]

### BACKGROUND

Generally, this application relates to techniques for securely transferring information amongst trusted parties.

In daily communications, there is a constant challenge to maintain the security and privacy of the information being transacted online as well as information relating to the parties involved in the transaction. Numerous daily interactions between interested parties via the Internet expose the various users to security and privacy risks relating to the transaction concerned. In addition, there are continuing challenges to maintaining the security of the relationships of a particular user to other users that he or she interacts with. Accordingly, there are significant technical challenges to enabling users to more easily manage these social and financial interactions while maintaining the appropriate level of security and/or safety within a particular contextual environment.

It may be useful to provide improved systems of securely transferring information via the Internet amongst trusted parties.

### SUMMARY

According to certain inventive techniques, a method includes the steps of: receiving, at a data processing system from a first client, a request for requested information associated with a second client; authenticating, by the data processing system, that the first client and the second client are authorized to communicate with each other; and if the first and second clients are authorized to communicate with each other, facilitating, by the data processing system, a transfer of requested information to the first client from at least one of the second client or another network component that stores the requested information on behalf of the second client, wherein the requested information is never received by the data processing system. The facilitating step may further include the steps of: transmitting, by the data processing system to the second client, the request for the requested information; and receiving, by the data processing system from the second client, an authorization to release the requested information. According to one technique, the requested information is stored by a vendor database on behalf of the second client and the facilitating step further includes instructing, by the data processing system to a vendor application server, an instruction to make the requested information available by writing the requested information to a vendor trusted database. According to one technique, the facilitating step further includes: receiving, by the data processing system from the vendor application server, an indication that the requested information is available for retrieval at the vendor trusted database; and transmitting, by the data processing system to the first client, the indication that the requested information is available. According to one technique, said receiving a request for requested information associated with a second client further comprises receiving a token, wherein the token includes a unique identifier for the first client and a unique identifier for the second client and said authenticating further comprises authenticating that the first and second clients are authorized to communicate with each other according to the unique identifiers for the first and second clients. According to one technique, said receiving a request for requested information associated with a second client further comprises receiving a token, wherein the token includes a unique identifier for the first client and a unique identifier for the second client, and prior to said transmitting, by the data processing system to the second client, the request for the requested information, determining, by the data processing system, an address for the second client according to the unique identifier of the second client.

According to certain inventive techniques, at least one computer-readable device includes instructions that, when executed by the at least one processor, cause operations including: receiving, at a data processing system from a first client, a request for requested information associated with a second client; authenticating, by the data processing system, that the first client and the second client are authorized to communicate with each other; and if the first and second clients are authorized to communicate with each other, facilitating, by the data processing system, a transfer of requested information to the first client from at least one of the second client or another network component that stores the requested information on behalf of the second client, wherein the requested information is never received by the data processing system. According to one technique, the operations further include: transmitting, by the data processing system to the second client, the request for information; and receiving, by the data processing system from the second client, an authorization to release the requested information. According to one technique, the operations further include: the requested information is stored by a vendor database on behalf of the second client; and said facilitating further comprises instructing, by the data processing system to a vendor application server, an instruction to make the requested information available by writing the requested information to a vendor trusted database. According to one technique, the operations further include: receiving, by the data processing system from the vendor application server, an indication that the requested information is available for retrieval at the vendor trusted database; and transmitting, by the data processing system to the first client, the indication that the requested information is available. According to one technique, the operations further include: said receiving a request for requested information associated with a second client further comprises receiving a token, wherein the token includes a unique identifier for the first client and a unique identifier for the second client; and said authenticating further comprises authenticating that the first and second clients are authorized to communicate with each other according to the unique identifiers for the first and second clients. According to one technique, the operations further include: said receiving a request for requested information associated with a second client further comprises receiving a token, wherein the token includes a unique identifier for the first client and a unique identifier for the second client; and prior to said transmitting, by the data processing system to the second client, the request for the requested information, determining, by the data processing system, an address for the second client according to the unique identifier of the second client.

According to certain inventive techniques, a method includes the steps of: receiving, by a data processing system from a first client, a request for requested information associated with a second client and a token, wherein the token includes a unique identifier for the first client and a unique identifier for a second client; authenticating, by the data processing system, that the first and second clients are authorized to communicate with each other according to the unique identifiers of the first and second clients; if the first and second clients are authorized to communicate with each other, transmitting, by the data processing system to the second client, the request for the requested information and the token; receiving, by the data processing system from the second client, the token and an authorization to release the requested information; transmitting, by the data processing system to an application server, the token and an instruction to make the requested information available; causing, by the application server, the requested information to be written to a database, wherein the requested information is associated with the token in the database; transmitting, by the application server to the data processing system, the token and an indication that the requested information is ready for retrieval from the database; transmitting, by the data processing system to the first client, the indication that the requested information is ready for retrieval from the database and the token; transmitting, by the first client to the database, a request to retrieve the requested information and the token; and comparing, by the database, the token received from the application server and the token received from the first client and, if the tokens correlate, transmitting the information from the database to the first client. According to one technique, the method further includes steps of: prior to said transmitting, by the data processing system to the second client, the request for the requested information and the token, determining, by the data processing system, an address for the second client according to the unique identifier of the second client; and prior to said transmitting, by the data processing system to the first client, the indication that the requested information is ready for retrieval from the database and the token, determining, by the data processing system, an address for the first client according to the unique identifier of the first client. According to one technique, the method further includes steps of: said receiving, by the data processing system from the second client, the token and an authorization to release the requested information further comprises receiving a unique identifier for the application server; and prior to said transmitting, by the data processing system to an application server, the token and an instruction to make the requested information available, determining, by the data processing system, an address for the application server according to the unique identifier for the application server.

According to certain inventive techniques, a method includes the steps of: receiving, by a data processing system from a first client, a communication directed to a second client that information associated with the first client is available for retrieval from a vendor server by the second client; authenticating, by the data processing system, that the first client and the second client are authorized to communicate with each other; and if the first and second clients are authorized to communicate with each other transmitting, by the data processing system to the second client, a communication indicating that the information associated with said first client is available for retrieval from the vendor server, wherein the information associated with said first client is never received by the data processing system. According to one technique, said receiving further comprises receiving a token, wherein the token includes a unique identifier for the first client and a unique identifier for the second client, and said authenticating further comprises authenticating that the first and second clients are authorized to communicate with each other according to the unique identifiers for the first and second clients.

According to certain inventive techniques, at least one computer-readable device includes instructions that, when executed by the at least one processor, cause operations including: receiving, by a data processing system from a first client, a communication directed to a second client that information associated with the first client is available for retrieval from a vendor server by the second client; authenticating, by the data processing system, that the first client and the second client are authorized to communicate with each other; and if the first and second clients are authorized to communicate with each other transmitting, by the data processing system to the second client, a communication indicating that the information associated with said first client is available for retrieval from the vendor server, wherein the information associated with said first client is never received by the data processing system. According to one technique, the operations further include: said receiving further comprises receiving a token, wherein the token includes a unique identifier for the first client and a unique identifier for the second client; and said authenticating further comprises authenticating that the first and second clients are authorized to communicate with each other according to the unique identifiers for the first and second clients.

According to certain inventive techniques, a method includes the steps of: generating, at a first client, a message and a token, wherein the token includes a unique identifier for the first client and a unique identifier for a second client; transmitting, by the first client and to a vendor server, the message, a retrieval key, and the token; storing, at the vendor server, the message and the retrieval key in association with the token; transmitting, by the first client and to a data processing system, the token, a retrieval key, and an indication that the message is available for retrieval from the vendor server; determining, at the data processing system, an address for the second client according to the unique identifier for the second client; transmitting, by the data processing system and to the second client, the token, the retrieval key, and an indication that the message is available for retrieval from the vendor server; transmitting, by the second client and to the vendor server, the token and the retrieval key; comparing, by the vendor server, the retrieval key received from the first client with the retrieval key received from the second client; and if the retrieval keys correlate, transmitting, by the vendor server and to the second client, the message.

### BRIEF DESCRIPTION OF SEVERAL VIEWS OF THE DRAWINGS

FIG. 1 illustrates a system and process for secure data transactions, according to certain inventive techniques.

FIG. 2 illustrates a system and process for secure data transactions, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

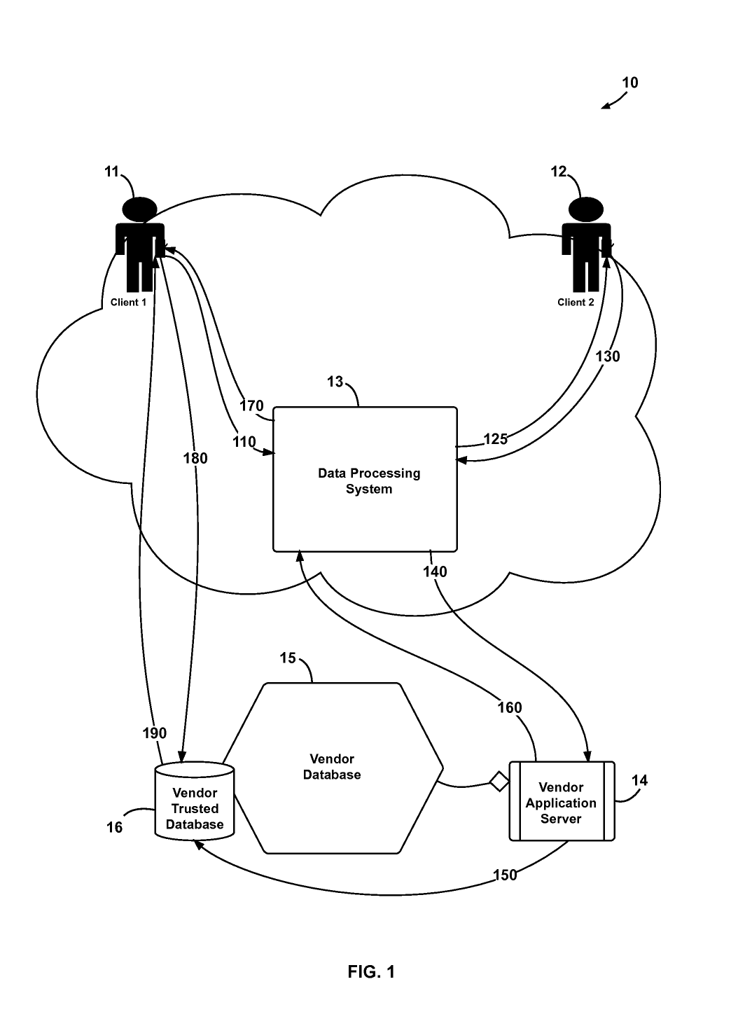

FIG. 1 illustrates a system and process 10 for secure data transactions, according to certain inventive techniques. The system 10 may include client 11, client 12, data processing system 13, vendor application server 14, vendor database 15, and/or vendor trusted database 16. The components of system 10 may be connected via one or more networks, such as the Internet.

As used herein, a “client” may refer to one or more software processes or applications running on a computing device or system (for example, a desktop computer, a laptop computer, or a hand-held device). A client may be controlled by an entity, such as a user.

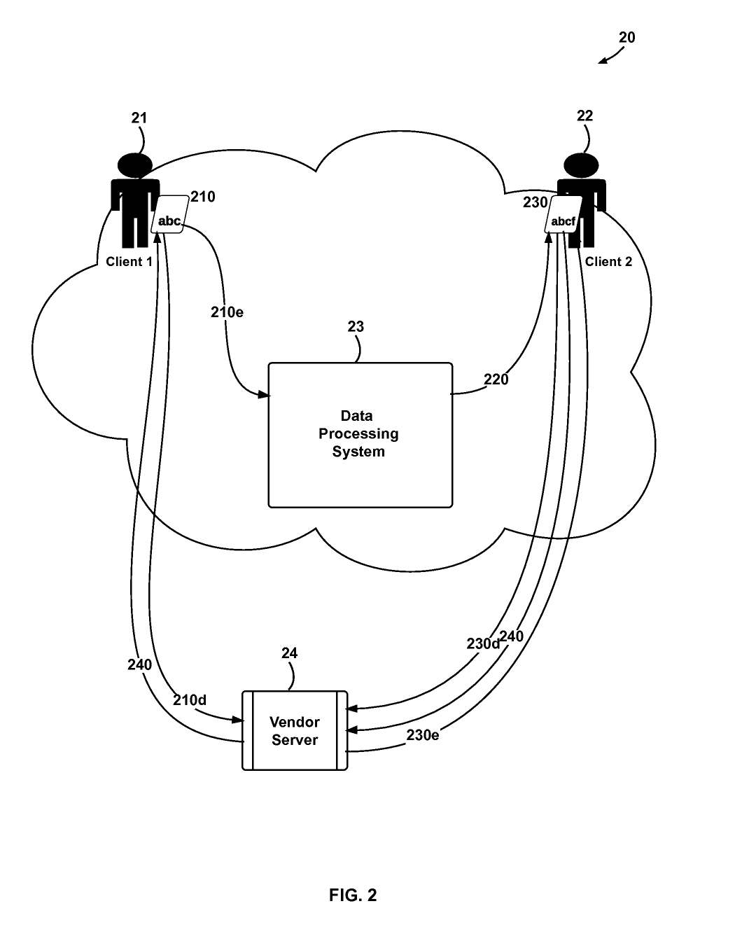

The data processing system 13 may include one or more network interfaces, through which communications with client 11, client 12, and application server 14 may be achieved. Note, the data processing system 13 may not communicate (and according to certain techniques, does not communicate) with the vendor trusted database 16. The data processing system 13 may include one or more processors. The processors may be in communication with one or more computer-readable devices (for example, RAM, ROM, EEPROM, flash memory, magnetic storage, optical storage, or the like). The computer-readable devices may store instructions that may be executed by the one or more processors. Such execution of instructions may cause data processing system 13 to perform operations discussed below. The data processing system 13 may be a server or a set of servers. The data processing system 13 may include or otherwise be associated with one or more storage units such as a database. Data processing system 23 (shown in FIG. 2) may have a similar configuration.

The vendor application server 14 may be comprised of one or more processors, data storage devices and any other electronic components and operating systems necessary to allow it to function as a server and run applications developed specifically to communicate and accept instructions from the data processing system 13. The vendor application server 14 may be owned by and under both the physical and data access control of the vendor.

A vendor database server 15 may be comprised of one or more processors, data storage devices and any other electronic components and operating systems necessary to allow it to function as a database server and run applications developed specifically to communicate and accept instruction from the vendor application server 14. The vendor database server 15 may be owned by and under both the physical and data access control of the vendor.

The vendor trusted database 16 is defined as any database that while not in the physical control of the vendor is under the data access control of the vendor and as such the data contents therein is their property and responsibility. This can include hosted data/server solutions. The vendor trusted database 16 may be a write-once database.

Prior to initiation of the process depicted in FIG. 1, parties to a transaction (for example, the entity controlling client 11 and the entity controlling client 12) may agree to be part of a trusted network, and thus become trusted parties. The parties may become trusted by registering or otherwise communicating with data processing system 13 via their clients to receive a unique identifier. The clients may then become trusted. The parties, via their clients for example, may share their unique identifiers with each other or otherwise become aware of each other's unique identifiers. Data processing system 13 may maintain a list of trusted parties (or clients of parties) and associated unique identifiers. Data processing system 13 may also maintain list of corresponding IP addresses for each unique identifier. Data processing system 13 may avoid issuing duplicate unique identifiers by allowing only one unique identifier per IP address.

Trusted clients participating in a transaction may be able to encrypt and decrypt trusted communications between each other. In other words, one client may encrypt a communication destined for another client and the receiving client may have the key to decrypting said communication. The key may be provided, for example, by data processing system 13, based on the client's membership in a trusted network. Data processing system 13 may also be capable of encrypting/decrypting trusted communications between or associated with the trusted clients/parties.

FIG. 1 depicts a system 10 and process by which information corresponding to the entity in control of client 12 is held in a vendor database 15 on behalf of the entity in control of client 12. As an initial presumption, the entity in control of client 11 wishes to obtain this information.

The process depicted in FIG. 1 may then begin at step 110. Upon an entity's initiation, client 11 may construct a communication to request information associated with client 12. The communication may include a request for the information and a token. The token may include the unique identifiers of both client 11 and client 12. The token may be used as a packet header. The communication, or a portion thereof, may be encrypted. Client 11 may then communicate or transmit this communication to data processing system 13.

At step 120 (not depicted and performed internally by data processing system 13), data processing system 13 may then receive and decrypt the communication. Data processing system 13 may also authenticate the identity of client 11, for example, by verifying that the unique identifier of client 11 is a valid identifier in the trusted network. Data processing system 13 may then construct a new communication including the token, the request for information, and/or an indication that the communication is authentic or has been vetted by data processing system 13. This new communication may be encrypted. Data processing system 13 may determine an address for client 12 or route the communication to client 12 according to the unique identifier of client 12 (contained in the token). At step 125, this communication is transmitted from data processing system 13 to client 12.

At step 130, client 12 may receive the communication from data processing system 13 and decrypt it. Again, client 12 may have a decryption/encryption key by virtue of being a member of the trusted network. Client 12 may analyze the request for information and determine whether or not to release the information to client 11. For example, a user controlling client 12 may determine whether he or she wants a user controlling client 11 to have the requested information.

If the release of information is not authorized, then the data processing system 13 transmits a message to client 11 that the requested information will not be shared. Optionally, such a message may further include various explanations for the denial of transmittal and/or remedial measures that may be taken. If the release of information is authorized, then client 12 may construct a communication including an authorization to release the information. The communication may specify, in the authorization, the information to be shared with client 11 (although the identity of client 11 or the corresponding entity may not be specified). The communication may also include a format in which the requested information is to be provided. The communication may also include the token. The communication may also include a unique identifier for the vendor. Such an identifier may be included in the token. The communication may also include a payload key. The payload key itself may be encrypted. The entire communication (which may include the already-encrypted payload key) may be encrypted. This communication may then be forwarded to data processing system 13.

Data processing system 13 may receive the communication from client 12 and decrypt the communication, but data processing system 13 may not decrypt the payload key. Data processing system 13 may parse the authorization and construct assembly instructions for the payload. Data processing system may then combine these elements, the token, and the request for information and encrypt them (either completely or partially) in a new communication, which is transmitted to the vendor application server 14 in step 140.

The vendor application server 14 may then receive the communication from data processing system 13 at step 140. The vendor application server 14 may decrypt the communication and may separately decrypt the payload key. The vendor application server 14 may then retrieve the requested information to be shared. The vendor application server 14 may retrieve such data from the vendor database 15. The vendor application server 14 may then compile the retrieved information to be shared in a payload. The format of the payload may be determined according to the assembly instructions. The vendor application server 14 may encrypt the information to be shared with the payload key. A retrieval key may also be generated, and it may be separately encrypted.

The vendor application server 14 may communicate, at step 150, the payload and the retrieval key to the vendor trusted database 16. The vendor application server may also communicate the token to the vendor trusted database. For example, the vendor application server 14 may write the payload (which may be separately encrypted) and/or the retrieval key to a memory address (or range of addresses) corresponding to the token in the vendor trusted database 16. The vendor application server 14 may also specify expiration data to the vendor trusted database 16 which may specify a time limit for storing or providing the data (after which, the data may be deleted or otherwise inaccessible).

At step 160, the vendor application server 14 may inform data processing system 13 that the information to be shared is ready for retrieval. The vendor application server 14 may communicate to data processing system 13 the token, the retrieval key (which may be separately encrypted), and an indication that the information to be shared is ready for retrieval. The expiration data may also be communicated. The overall communication or parts thereof may be encrypted.

At step 170, data processing system 13 may inform client 11 that the information to be shared is ready for retrieval. Data processing system 13 may determine an address for or route the communication to client 11 according to the unique identifier of client 11 contained in the token. Data processing system 13 may communicate to client 11 an indication that the information is available from the vendor trusted database 16. Data processing system 13 may also provide the retrieval key (which may be separately encrypted) and the token to client 11. Data processing system may also provide the payload key (which may be separately encrypted) and the expiration data. The overall communication from data processing system to client 11 at step 170 may be encrypted, or parts thereof.

Client 11 may decrypt the communication from data processing system. With the understanding that the requested information (from step 110) is now available for retrieval, client 11 may communicate the token (which may be separately encrypted) and the retrieval key (which may be separately encrypted) to the vendor trusted database 16 at step 180. The entire communication, or parts thereof, may be encrypted.

The vendor trusted database 16 may receive the communication from client 11 and decrypt the retrieval key and/or the token. The vendor trusted database 16 may then authenticate the retrieval key (for example, compare the retrieval key received at step 180 with that received at step 150). If the retrieval key is valid, then the vendor trusted database 16 may generate a communication including the payload (which may be separately encrypted) and the token. The payload may be encrypted according to the payload key. The payload may be stored as encrypted data. The communication may also include the expiration data. The overall communication, or parts thereof, may be encrypted.

This communication may then be transmitted from the vendor trusted database 16 to client 11 at step 190. The communication may also include the token and the expiration data. The overall communication or parts thereof may be encrypted. Client 11 may the decrypt the package and the encapsulated payload to obtain the requested information from step 110.

Throughout the process described above with respect to FIG. 1, the data processing system 13 may generally serve to authenticate the parties involved in the transaction. At the same time, the shared or requested information may never pass through data processing system 13. According to one technique, the requested information never passes through data processing system 13. Data processing system 13 may also include information that allows it to authenticate parties according to their unique identifiers in the token.

Looking generally at FIG. 1 and with reference to the foregoing discussion, it can be seen that the requested information is never received by data processing system 13. Thus, data can be transferred via the Internet between parties while maintaining the security and privacy of all involved parties without exposing data processing system 13 (and the company that operates data processing system 13) to risks associated with the transmission of private data. Instead of actually receiving and transmitting the requested information, data processing system 13 only facilitates the transfer of the second entity's requested information to the first client. These facilitation steps may include one or more of steps 125, 130, 140, 160, and 170. Steps 180 and 190 are performed independently of data processing system 13. Step 150 may also performed independently, but may also be performed at the instruction of data processing system 13. While FIG. 1 depicts a technique whereby data is held by the vendor, data processing system 13 may also facilitate transfer of requested information when the data is held by second client 12.

The table below illustrates different uses or implementations of system 10.

| | | | | Requested |
|---|---|---|---|---|
| Field of Use | Client 11 | Client 12 | Vendor | Information |
| Blind/Sighted Data | Any | Any | Any | Any |
| Exchange | individual/entity | individual/entity | vendor | requested |
| | | | who stores | information |
| | | | data for | |
| | | | Entity 2 | |
| Health Record Transport | New physician | Patient | Previous | The patient's |
| | office | | physician | electronic |
| | | | office's | medical |
| | | | electronic | records |
| | | | health | stored at the |
| | | | system | old |
| | | | | physician's |
| | | | | electronic |
| | | | | health |
| | | | | system |
| Voting/Referendum/Polling | Poll/election | Citizen | Identity | Proof of |
| Platform | authority | | verification | identity |
| | | | authority | |
| Access Control and | Individual | Security | Access | Access code |
| Security | needing | authority | Control | or |
| | physical access | controlling | database | information |
| | to a controlled | building | | |
| | area or building | | | |

These are just a few examples that illustrate how system 10 may be used. The first column describes different general fields of use. The second, third, and fourth columns indicate the different parties to a transaction. Note, for clients 11 and 12, the party indicated in the table may actually be the entity in control of a given client. The fifth column indicates the type or nature of the information to be shared by client 12 with client 11.

FIG. 2 illustrates a system 20 and process for secure data transactions, according to certain inventive techniques. The system 20 may include a client 21, a client 22, a data processing system 23, and a vendor server 24. Clients 21, 22 may be similar to clients 11 or 12. Data processing system 23 may be similar to data processing system 23. Vendor server 24 may be an email server or a server for a bank. The components of system 10 may be connected via one or more networks, such as the Internet.

Prior to initiation of the process depicted in FIG. 2, parties to a transaction (for example, the entity controlling client 21 and the entity controlling client 22) may agree to be part of a trusted network, and thus become trusted parties. The parties may become trusted by registering or otherwise communicating with data processing system 23 via their clients to receive a unique identifier. The clients 21, 22 may then become trusted. The parties, via their clients, may share their unique identifiers with each other or otherwise become aware of each other's unique identifiers. Data processing system 23 may maintain a list of trusted parties (or clients of parties) and associated unique identifiers. Trusted clients participating in a transaction may be able to encrypt and decrypt trusted communications between each other. In other words, one client may encrypt a communication destined for another client and the receiving client may have the key to decrypting said communication. The key may be provided, for example, by data processing system 23, based on the client's membership in a trusted network. Data processing system 23 may also be capable of encrypting/decrypting trusted communications between or associated with the trusted clients/parties.

FIG. 2 depicts a system 20 and process by which the entity in control of client 21 wishes to share private data with the entity in control of client 22. At step 210a, client 21 may be operated by an entity who selects client 22 (associated with a different entity) as a recipient. A token may be generated and includes a unique identifier for client 21 and a unique identifier for client 22. At step 210b, a message may be generated by client 21. For example, the entity in control of client 21 may type an email and attach attachments, or the entity may generate instructions for transfer of his or her funds from a bank. At step 210c, client 21 may generate a payload key. Client 21 may encapsulate and encrypt the contents of the message (for example, a payload) with the payload key.

At step 210d, client 21 may transmit the contents of the message along with the token to vendor server 24. Client 21 may also transmit a retrieval key to vendor server 24. The communication from client 21 to vendor server 24, or a portion thereof, may be encrypted. Vendor server 24 may decrypt this information and store it in a database associated with vendor server 24. For example, the message (the message may still be encrypted with the payload key) and the retrieval key may be stored at an address (or range of addresses) that are associated with the token. At step 210e, client 21 may transmit the token along with the payload key to data processing system 23. The token may be used as a packet header. Client 21 may also transmit the retrieval key and recipient information to data processing system 23 at step 210e. One or more of these portions of the communication may ultimately indicate to the second client that the first client is trying to send a message to the second client. The entire communication, or portions thereof, may be encrypted.

Data processing system 23 may decrypt the communication received from client 21 at step 210e. Data processing system 23 may verify the identity of client 21 based on the unique identifier for client 21 contained in the token. Data processing system 23 may also determine an address or otherwise route the token, payload key, recipient information, and retrieval key to client 22. This communication, or portions thereof, may be encrypted. At step 220, this communication may be transmitted from data processing system 23 to client 22. Optionally, the retrieval key may not be transmitted at step 220.

At step 230a, client 22 may receive the communication from data processing system 23 and may decrypt the communication. At step 230b, client 22 may verify the identity of client 21 and may then obtain the retrieval key from data processing system 23. At step 230c, the entity in control of client 22 may choose to retrieve the message sent by client 21 to vendor server 24 in step 210d.

If the entity in control of client 22 chooses to retrieve the message from vendor server 24, then client 22 may transmit the retrieval key and the token to vendor server 24 at step 230d. This communication may include a request to retrieve the message from the vendor server 24. This communication, or parts thereof, may be encrypted. Vendor server 24 may then decrypt the communication and compare the retrieval key to that received at step 210d. If the retrieval keys correlate, then vendor server 24 may transmit the message (that may be encrypted by the payload key) and the token to client 22 at step 230e.

This communication, or a portion thereof, may be encrypted. At step 230f, client 22 may receive and decrypt the communication received at step 230e. Client 22 may then decrypt the message using the payload key received at step 220. Thus, the entity in control of client 22 may be able to view or process the message originally sent by client 21 at step 210d.

At step 240, client 22 may send an acknowledgement communication to vendor server 24 that the message was received. This communication may include a receipt that the process was completed, a destruction authorization, and the token. All or parts of this communication may be encrypted. Vendor server 24 may receive this communication and decrypt it. Vendor server 24 may erase or otherwise destroy the stored message according to the destruction authorization. Vendor server 24 may then communicate the receipt that the process was completed and the token back to client 21.

Looking generally at FIG. 2 and with reference to the foregoing discussion, it can be seen that the shared information is never received by data processing system 23. Thus, data can be transferred via the Internet between parties while maintaining the security and privacy of all involved parties without exposing data processing system 23 (and the company that operates data processing system 23) to risks associated with the transmission of private data. Instead of actually receiving and transmitting the requested information, data processing system 23 only facilitates the transfer of the second entity's requested information to the first client. Facilitation steps may include, for example, step 220. Steps 230a-f are performed independently of data processing system 23.

The table below illustrates different uses or implementations of system 20.

| | | | | Requested |
|---|---|---|---|---|
| Field of Use | Client 21 | Client 22 | Vendor | Information |
| Alternative | Person initiating | Person | Bank | Funds |
| currency | transfer of funds | receiving | | |
| exchange | | funds | | |
| Secure e-mail | Person sending | Person | Email | Email |
| or data | mail | receiving | vendor | |
| exchange | | mail | | |
| Voucher/ | Person initiating | Person | Bank | Funds |
| Rebate | transfer of funds | receiving | | |
| Distribution & | | funds | | |
| Control | | | | |

These are just a few examples that illustrate how system 20 may be used. The first column describes different general fields of use. The second, third, and fourth columns indicate the different parties to a transaction. Note, for clients 21 and 22, the party indicated in the table may actually be the entity in control of a given client. The fifth column indicates the type or nature of the information to be shared by client 21 with client 22.

In the example for email communications, the process depicted in FIG. 2 may be executed in the following manner. A user has an email snap-in or plug-in in the user's email client 21. The email client 21, then, facilitates or is aware of the fact that client 22 is a trusted party. At steps 210a-210c, the user selects client 22 as a recipient for an email. The user then composes an email message and includes an attachment (hereinafter, the message refers to the message and attachment). The user then indicates that the email is to be sent. Client 21 then composes a communication that includes the message which is encrypted with the payload key. The token and a retrieval key are added to the communication, and the entire communication is encrypted. Thus, the message is encrypted twice. This communication is sent to vendor server 24 at step 210d.

Vendor server 24 receives and decrypts the communication from step 210d. Vendor server 24, in a database, stores the encrypted message and the retrieval key at a range of addresses associated with the token.

Client 21 also generates another communication. Client 21 composes a communication that includes a token comprising a unique identifier for client 21 and a unique identifier for client 22. Client 21 generates a payload key and encapsulates or encrypts the payload key as part of the communication. Client 21 also includes a retrieval key and an indication that the message is available for retrieval as part of the communication. The entire communication, including the already-encrypted payload key, is encrypted. Thus, the payload key is twice-encrypted. This communication is then sent to data processing system 23 at step 210e. The message is not sent to data processing system 23.

Data processing system 23 decrypts this communication and verifies the identity of client 21 according to its unique identifier in the token. Data processing system 23 is able to verify the identity of client 21 because a table is maintained that lists all of the trusted parties and their associated unique identifiers. After the communication from client 21 has been verified as a communication from a trusted party, data processing system determines an address for client 22 according to the unique identifier of client 22 in the token. Data processing system 23 then forwards the encapsulated payload key, the indication that the message is available, and the token to client 22 in an encrypted communication at step 220.

At steps 230a-230c, client 22 decrypts the communication (including the twice-encrypted payload key) from data processing system 23. The user in control of client 22 receives the indication that the message is available. The user in control of client 22 determines that client 21 is trusted and opts to retrieve the message. The client 22 then receives the retrieval key from data processing system 23. Client 22 then composes a communication including the retrieval key and the token, and it is transmitted to vendor server 24 at step 230d.

Vendor server 24 then decrypts the communication and retrieves the data (encrypted message and retrieval key) stored at the range of addresses associated with the token. Vendor server 24 verifies that the retrieval key is correct and, if so, transmits the encrypted message and the token to client 22 at step 230e. This communication is, itself, encrypted. Therefore, the message is twice-encrypted.

At step 230f, client 22 decrypts this communication and then decrypts the message using the payload key. The message (including the attachment) is then presented to the user by client 22. At step 240, client 22 sends a communication including an acknowledgement to vendor server 24 that the message has been received. This communication also includes an authorization to destroy the message and the token. This communication is encrypted.

Vendor server 24 decrypts this communication and then destroys (or otherwise makes inaccessible) the message and retrieval key. Vendor server 24 also communicates the acknowledgement that the message has been received and the token to client 21. Thus, the process depicted in FIG. 2 concludes.

According to certain inventive techniques, the vendor may not have any information regarding the identity of a data retrieving client (for example, personal identifying information such as name, social security number, home address, or the like), such as client 11 or client 22. The vendor, however, may be aware or know specifics about the data to be shared. By contrast, a data processing system (for example, systems 13 or 23) may possess identifying information for participating trusted parties, but it may never know or have access to the underlying data to be shared. This implementation protects the anonymity of the entity who is receiving or retrieving protected information. In other words, the transfer of protected information may be a blind transfer.

There may be other blind aspects to these systems as well. For example, the entity requesting information (for example, the entity in control of client 11 or client 21) may not know anything about the vendor. On the other hand, the vendor may be aware of identifying information of an authorizing entity (for example, the entity in control of client 12 or client 21). Contrastingly, only the data processing system may be able to correlate IP addresses of the parties to the transaction with their corresponding unique identifiers.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that

they will include all techniques falling within the scope of the appended claims.

1. A method comprising:
receiving, at a data processing system from a first client, a request for requested information associated with a second client;
authenticating, by the data processing system, that the first client and the second client are authorized to communicate with each other; and
if the first and second clients are authorized to communicate with each other, facilitating, by the data processing system, a transfer of requested information to the first client from at least one of the second client or another network component that stores the requested information on behalf of the second client,
wherein the requested information is never received by the data processing system.

2. The method of claim 1, wherein said facilitating further comprises:
transmitting, by the data processing system to the second client, the request for the requested information; and
receiving, by the data processing system from the second client, an authorization to release the requested information.

3. The method of claim 2, wherein:
the requested information is stored by a vendor database on behalf of the second client; and
said facilitating further comprises instructing, by the data processing system to a vendor application server, an instruction to make the requested information available by writing the requested information to a vendor trusted database.

4. The method of claim 3, wherein said facilitating further comprises:
receiving, by the data processing system from the vendor application server, an indication that the requested information is available for retrieval at the vendor trusted database; and
transmitting, by the data processing system to the first client, the indication that the requested information is available.

5. The method of claim 4, wherein:
said receiving a request for requested information associated with a second client further comprises receiving a token, wherein the token includes a unique identifier for the first client and a unique identifier for the second client; and
said authenticating further comprises authenticating that the first and second clients are authorized to communicate with each other according to the unique identifiers for the first and second clients.

6. The method of claim 2, wherein:
said receiving a request for requested information associated with a second client further comprises receiving a token, wherein the token includes a unique identifier for the first client and a unique identifier for the second client; and
prior to said transmitting, by the data processing system to the second client, the request for the requested information, determining, by the data processing system, an address for the second client according to the unique identifier of the second client.

7. A method comprising:
receiving, by a data processing system from a first client, a communication directed to a second client that information associated with the first client is available for retrieval from a vendor server by the second client;
authenticating, by the data processing system, that the first client and the second client are authorized to communicate with each other; and
if the first and second clients are authorized to communicate with each other transmitting, by the data processing system to the second client, a communication indicating that the information associated with said first client is available for retrieval from the vendor server,
wherein the information associated with said first client is never received by the data processing system.

8. The method of claim 7, wherein:
said receiving further comprises receiving a token, wherein the token includes a unique identifier for the first client and a unique identifier for the second client; and
said authenticating further comprises authenticating that the first and second clients are authorized to communicate with each other according to the unique identifiers for the first and second clients.

9. A method comprising:
generating, at a first client, a message and a token, wherein the token includes a unique identifier for the first client and a unique identifier for a second client;
transmitting, by the first client and to a vendor server, the message, a retrieval key, and the token;
storing, at the vendor server, the message and the retrieval key in association with the token;
transmitting, by the first client and to a data processing system, the token, a retrieval key, and an indication that the message is available for retrieval from the vendor server;
determining, at the data processing system, an address for the second client according to the unique identifier for the second client;
transmitting, by the data processing system and to the second client, the token, the retrieval key, and an indication that the message is available for retrieval from the vendor server;
transmitting, by the second client and to the vendor server, the token and the retrieval key;
comparing, by the vendor server, the retrieval key received from the first client with the retrieval key received from the second client; and
if the retrieval keys correlate, transmitting, by the vendor server and to the second client, the message.
